(19) United States
(12) Patent Application Publication
(10) Pub. No.: US 2004/0249674 A1
(43) Pub. Date: Dec. 9, 2004

(54) Personnel and process management system suitable for healthcare and other fields

(76) Inventors: Floyd P. Eisenberg, Amber, PA (US); Darren Selsky, West Chester, PA (US)

Correspondence Address: Alexander J. Burke, Intellectual Property Department, 5th Floor, 170 Wood Avenue South, Iselin, NJ, 08830, US

(21) Appl. No.: 10/830,744

(22) Filed: Apr. 23, 2004

Related U.S. Application Data
(60) Provisional application No. 60/468,249, filed on May 6, 2003.

(51) Int. Cl. G06F 17/60

(52) U.S. Cl. 705/2

(57) ABSTRACT

A system supports providing healthcare to individual patients. The system includes an interface processor and a management processor. The interface processor receives information in one or more messages initiated by a particular healthcare worker. The received information identifies the particular healthcare worker, a particular patient, and a healthcare role. The healthcare role identifies a work function to be performed by the particular healthcare worker for the particular patient. The management processor updates an information repository to include the received information.

### CROSS-REFERENCE TO RELATED APPLICATIONS

The present application is a non-provisional application of provisional application having Ser. No. 60/468,249 filed by Floyd P. Eisenberg, et al. on May 6, 2003.

### FIELD OF THE INVENTION

The present invention generally relates to healthcare information systems. More particularly, the present invention relates to a personnel and a process management system suitable for healthcare and other fields.

### BACKGROUND OF THE INVENTION

Present healthcare information systems support care provider lists and care list management by human intervention to keep the list and roles up-to-date, whether on paper or in an information system file. These systems are limited due to the cumbersome and labor-intensive human tasks involved in managing care provider lists and because the management occurs in a disjointed, manual fashion. Patients have the capability in some existing systems to schedule appointments with individual care providers in ambulatory settings and to select primary care providers based on available credentials. However, there is a need for an automated system that permits patients to manage a full list of active clinical caregivers, understand their roles and responsibilities, and veto or recommend individual practitioners of care for each role or responsibility.

Privileging is typically performed to encourage safe patient care practices by allowing individual practitioners of care to perform only those services with which they have sufficient experience, expertise, and skill. A patient's knowledge of privileges is typically limited and results in significant risk of allowing procedures to be performed by non-privileged practitioners, raising the potential for unsafe care delivery. Accordingly, there is a need for a process management system suitable for healthcare and other fields that overcomes these and other disadvantages of the prior systems.

### SUMMARY OF THE INVENTION

According to one aspect of the present invention, a system supports providing healthcare to individual patients. The system includes an interface processor and a management processor. The interface processor receives information in one or more messages initiated by a particular healthcare worker. The received information identifies the particular healthcare worker, a particular patient, and a healthcare role. The healthcare role identifies a work function to be performed by the particular healthcare worker for the particular patient. The management processor updates an information repository to include the received information.

### BRIEF DESCRIPTION OF THE DRAWINGS

FIG. 1 illustrates a healthcare provider management system providing individual healthcare provider access, in accordance with a preferred embodiment of the present invention.

FIG. 2 shows a patient system 200 providing patient management of a healthcare provider list, in accordance with a preferred embodiment of the present invention.

FIG. 3 illustrates a healthcare provider subscription process for the subscription processor, as shown in FIG. 1, in accordance with a preferred embodiment of the present invention.

FIG. 4 illustrates a presentation displayed to a healthcare provider for the process, as shown in FIG. 3, in accordance with a preferred embodiment of the present invention.

### DETAILED DESCRIPTION OF THE PREFERRED EMBODIMENTS

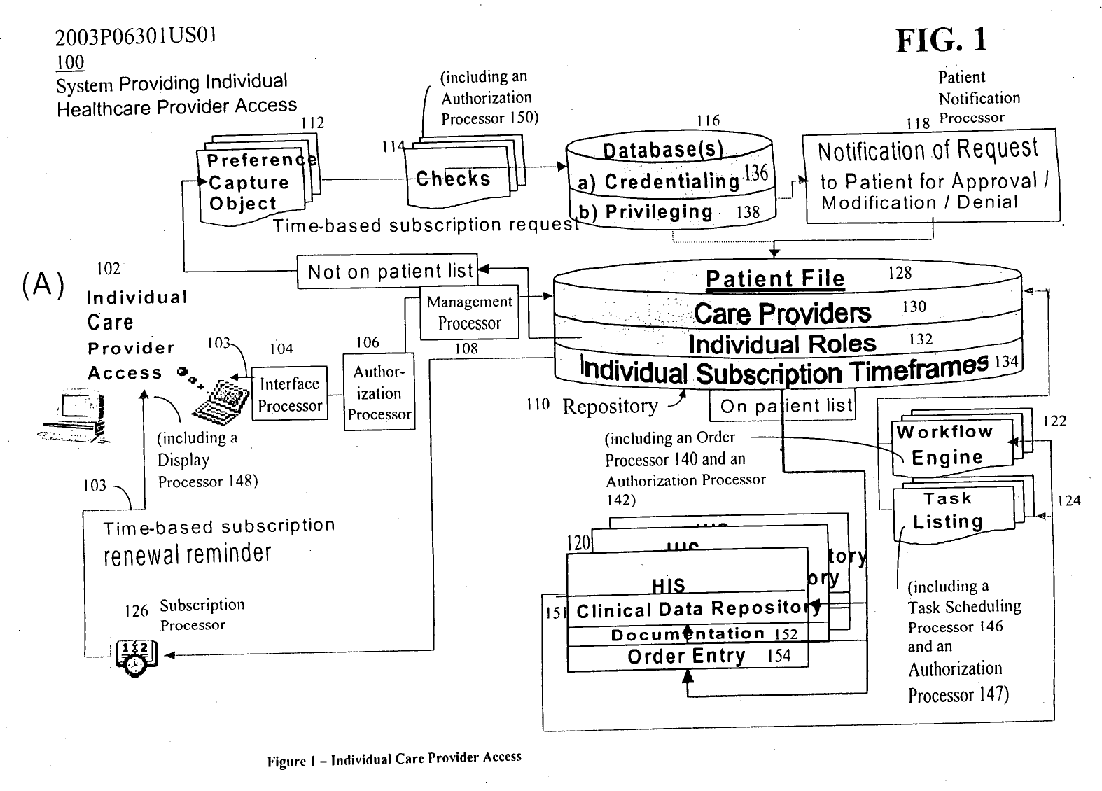

FIG. 1 illustrates healthcare provider management system 100 providing individual healthcare provider access (herein called the “provider system”), in accordance with a preferred embodiment of the present invention. Generally, the provider system 100 includes an electronic device 102, an interface processor 104, an authorization processor 106, a management processor 108, a repository 110, a preference capture object 112, a preference check 114, a database 116, a notification processor 118, a hospital information system 120, a workflow engine 122, a task listing 124, and a subscription processor 126.

In particular, the repository 110 further includes a patient file 128, information on healthcare providers 130, information on individual roles 132 of healthcare providers, and timeframes 134 for individual subscriptions. The database 116 further includes information about credentialing 136 and privileging 138 for healthcare providers. The workflow engine 122 further includes an order processor 140 and an authorization processor 142. The task listing 124 further includes a task scheduling processor 146 and an authorization processor 147. The electronic device 102 further includes a display processor 148. The preference check 114 further includes an authorization processor 150. The hospital information system 120 further includes, without limitation, a clinical data repository 151, documents 152, and orders 154.

The provider system 100 supports providing healthcare related goods or services for use in providing healthcare to individual patients. The provider system 100 is intended for use by a healthcare provider that is responsible for servicing the health and/or welfare of people in its care. Thus, a healthcare provider may provide services directed to the mental, emotional, or physical well being of a patient. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. When servicing a person in its care, a healthcare provider diagnoses a condition or disease, and recommends a course of treatment to cure the condition, if such treatment exists, or provides preventative healthcare services. Examples of the people being serviced by a healthcare provider include, without limitation, a patient, a resident, a client, a user, and an individual.

The electronic device 102 provides an electronic mechanism for a healthcare provider (otherwise called a “healthcare worker”) to access the provider system 100. The electronic device 102 may be fixed or mobile (i.e., portable), and may be implemented in a variety of forms including, without limitation, a desktop computer, a laptop computer, a workstation, a network-based device, a personal digital assistant (PDA), a smart card, a cellular telephone, a pager, and a wristwatch. The electronic device 102 may be implemented in a centralized or decentralized configuration.

Preferably, the electronic device 102 includes a user interface (not shown) having an input device (not shown) that permits a user to input information into the electronic device 102 and an output device (not shown) that permits a user to receive information from the electronic device 102. Preferably, the input device is a keyboard, but also may be a touch screen, or a microphone with a voice recognition-program, for example. Preferably, the output device is a display, but also may be a speaker, for example. The output device provides information to the user in response to the input device receiving information from a user or in response to other activity by the electronic device 102. For example, a display presents information in response to a user entering information in the electronic device 102 via a keyboard.

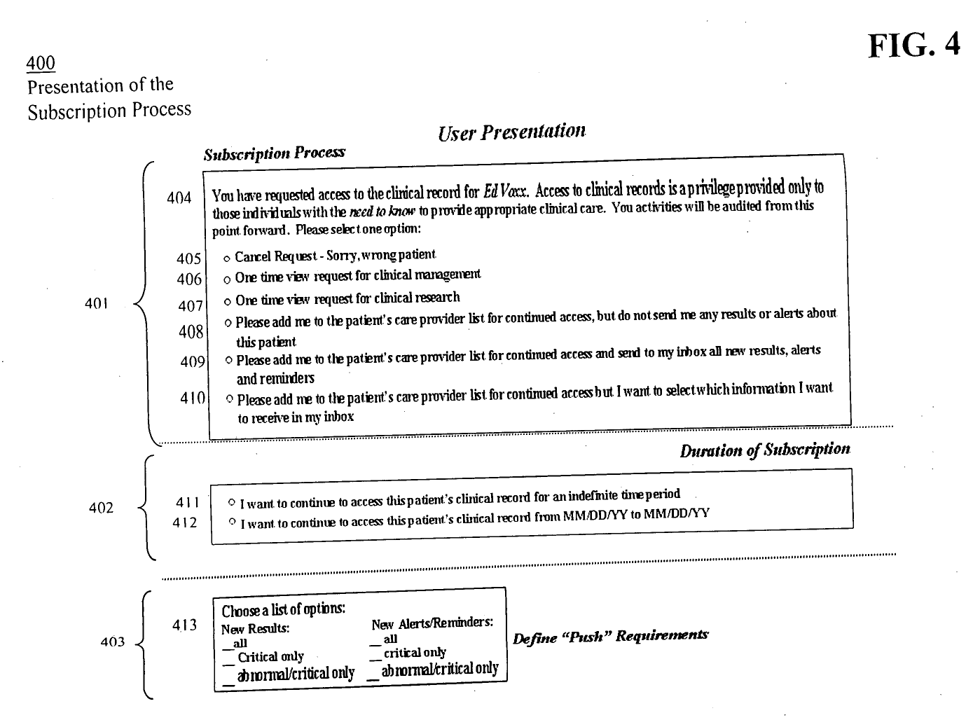

Preferably, the user interface provides a graphical user interface (GUI), wherein at least portions of the input device and at least portions of the output device are integrated together to provide a user-friendly device. For example, a web browser forms a part of each of the input device and the output device by permitting information to be entered into the web browser and by permitting information to be displayed by the web browser. Many different GUI techniques for inputting data and outputting data, preferably using a browser interface, may be implemented for efficiency and ease of use including, without limitation, selection lists, selection icons, selection indicators, drop down menus, entry boxes, slide bars, search queries, hypertext links, Boolean logic, template fields, natural language, stored predetermined queries, system feedback, and system prompts. Preferably, the user interface includes a display processor 148 for initiating generation of one or more display images supporting user entry of received input information, such as the display image shown in FIG. 4.

The interface processor 104 receives information in one or more messages initiated by a particular healthcare worker using the electronic device 102. According to one aspect of the present invention, the received information identifies the particular healthcare worker, the particular patient, and the healthcare role identifying a work function to be performed by the particular healthcare worker for the particular patient. In particular, the received information identifies one or more of the following: (a) a start date of the particular healthcare worker being assigned to perform the particular healthcare role, (b) an end date of the particular healthcare worker being assigned to perform the particular healthcare role, (c) a type of data the particular healthcare worker is authorized to access, (d) authorization of the particular healthcare worker to perform the particular healthcare role, and (e) credentials of the particular healthcare worker.

According to another aspect of the present invention, the received information identifies a type of data the particular healthcare worker is authorized to access, and a notification communication method the particular healthcare worker desires to be used in communicating the type of data to the particular healthcare worker.

According to yet another aspect of the present invention, the interface processor 104 supports communication with a particular patient, and enables access of the particular patient to the repository 110 of information to: (a) identify a healthcare worker assigned to perform a healthcare role for the particular patient, and/or (b) select a healthcare worker to perform a healthcare role for the particular patient.

The electronic device 102 communicates with the interface processor 104 and the subscription processor 126 over a communication path 103. The term “path” may otherwise be called a network, a link, a channel, or a connection. The communication path 103 may be the same path or different paths for each of the interface processor 104 and the subscription processor 126, depending on the particular provider system 100.

The communication path 103 may use any type of protocol, otherwise called data format, including, without limitation, an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, an Institute Of Electrical And Electronic Engineers (IEEE) bus compatible protocol, and an Health Level Seven (HL7) protocol.

The communication path 103 may use any type of address scheme including, without limitation, an address corresponding to a type of protocol described above, and a Universal Resource Locator (URL), otherwise called a web page address. The communication path 103 may communicate any type of data for any type of application including, without limitation, still pictures, streaming video, audio, telephone messages, computer programs, messages, instructions, and Emails.

The communication path 103 may be formed as a wired and/or wireless (W/WL) connection. A wireless connection advantageously permits the electronic device 102 to be mobile beyond the distance permitted by the wired connection. Preferably, the communication path 103 is formed as a wired connection. The wired connection may include physical wires formed as a serial or parallel bus. Preferably, in the case of a wired connection, an IP address may be assigned to a physical location of the termination point of the wire. In the case of a wireless connection, the IP address may be assigned to the provider system 100, since the provider system 101 would be mobile.

The communication path 103 may be formed as any type of network including, without limitation, a local area network (LAN), such as an Intranet, for example, and a wide area network (WAN), such as an Internet, for example. Preferably, the communication path 103 is formed as the WAN, such as the Internet. The Internet is a decentralized network of computers that communicate with one another via TCP/IP.

Preferably, the electronic device is considered a client and the remaining elements of the provider system 100 are considered part of a server to form a client-server system. A web browser, such as Explorer™ (MicroSoft Corp.) or Navigator™ (Netscape Communication Corp.), installed on the client sends a message over the Internet to the server. The message requests a web page identified by a uniform resource locator (URL), which notes both the server where the web page resides and the file or files on that server which make up the web page. The server sends a copy of the requested file(s) to the web browser, which in turn displays the web page to the user. The web pages on the Internet may be hyper-media documents written in a standardized language called Hyper Text Markup Language (HTML). A typical web page includes text together with embedded formatting commands, referred to as tags, which can be used to control font size, font style and the like.

The authorization processor 104 determines whether an individual healthcare worker has: (a) authorization, and/or (b) necessary credentials to perform a particular role. The necessary credentials include one or more of the following: (i) educational qualifications, (ii) regulatory licenses, (iii) healthcare provider organization determined privileges, (iv) certifications, and (v) medical specialty qualifications.

According to another aspect of the present invention, the authentication processor 104 determines whether the individual healthcare worker has authorization to access patient medical data of a particular type. In response to a determination that the individual healthcare worker is not authorized to perform the particular role, the authentication processor performs one or more of the following: (a) inhibits update of the information repository to include information identifying the individual healthcare worker as being assigned to perform a particular healthcare role for a particular patient, (b) inhibits scheduling of a particular task for performance by the individual healthcare worker for a particular patient, and (c) initiates generation of an alert message to a predetermined user warning of the non-authorization determination.

The management processor 108 updates the repository 110 to include the received information. In particular, the management processor 108 updates the repository 110 to include information identifying a particular individual healthcare worker assigned to perform a particular healthcare role for a particular patient in response to a received message initiated by the particular individual healthcare worker.

The repository 110 includes a patient file 128 having a healthcare provider list including names 130, individual roles 132, and individual subscription timeframes 134 for each healthcare provider listed. A healthcare role identifies a work function to be performed by a healthcare worker for the individual patient. The healthcare roles include roles being performed at different locations. The roles include healthcare work functions associated with different parts of a treatment regimen including work functions associated with one or more of the following: (a), examination, (b) laboratory testing, (c) diagnosis, (d) treatment, (e) post-treatment, (f) therapy, and (g) physiotherapy. The role includes one or more of the following: (a) a nurse work function, (b) a physician work function, (c) an administrative work function, (d) a therapist work function, (d) a case manager work function, (e) a home aid work function, (f) a laboratory test support work function, (g) a technician work function, (h) a care unit support work function, (i) a nurse practitioner work function, (j) a physician assistant work function, and (k) a cleaning and resource supply work function. The roles include a role performed by a healthcare worker during an inpatient stay in a hospital and performed by a healthcare worker outside of the hospital. The roles also include clinical and administrative healthcare worker roles.

According to one aspect of the present invention, the repository 110 of information identifies, for an individual patient, multiple different healthcare roles, and multiple individual healthcare workers assigned to perform the roles. According to another aspect of the present invention, the repository 110 identifies for an individual patient, multiple different healthcare roles associated with multiple different organizations and performed at different locations associated with the different organizations. According to yet another aspect of the present invention, the repository 110 includes information identifying, for an individual patient, a healthcare role and a first individual healthcare worker assigned to perform the role, and a second individual healthcare worker to be informed in response to failure to acknowledge a task scheduled to be performed by the first individual healthcare worker. According to still yet another aspect of the present invention, the repository 110 of information identifies a plurality of prioritized individual healthcare workers for assignment to perform a particular healthcare role for a particular patient in a predetermined order based on worker availability. According to still yet another aspect of the present invention, the repository 110 of information identifies an individual healthcare worker assigned to perform a particular healthcare role for a particular patient and also identifies one or more of the following: (a) a start date of the individual healthcare worker being assigned to perform the particular healthcare role, (b) an end date of the individual healthcare worker being assigned to perform the particular healthcare role, (c) a type of data the individual healthcare worker is authorized to access, (d) authorization of the individual healthcare worker to perform the particular healthcare role, and (e) credentials of the individual healthcare worker.

According to still yet another aspect of the present invention, the repository 110 of information identifies, for an individual patient, multiple different healthcare roles indicating work functions to be performed by healthcare workers, multiple individual healthcare workers assigned to perform the roles, and individual healthcare worker authorization to perform a particular role. Preferably, the repository 110 of information identifies, for the individual patient, whether an individual healthcare worker has necessary credentials to perform a particular role.

The preference capture object 112 provides a mechanism, such as a display screen and/or a data set, to capture healthcare provider preferences (e.g., credentials, privileges) for a desired individual subscription (e.g., type of access, duration of access), in response to a determination that the healthcare provider is not on the patient's list of healthcare providers.

The preference check 114 provides a mechanism, such as a software algorithm, that determines whether the preferences for the desired individual subscription are acceptable to the provider system 100. Preferably, the preference check 114 makes the determination by comparing the information entered by the healthcare provider to the information stored in the database 116. An authorization processor 150 included in the preference check 114 determines whether the healthcare provider is authorized to provide the healthcare provider preferences and/or is authorized to request an individual subscription.

The database 116 includes credentialing information 136 and privileging information 138. There may be one or multiple databases in a particular provider system 100. The database 116 provides the information 136, 138 to the preference check 114 to determine the healthcare provider's credentials (e.g., training and licensure) to access the patient's record and to determine the healthcare provider's privileges (e.g., sufficient experience) to perform requested tasks (e.g., administer medication, perform surgery, etc.).

The patient notification processor 118 provides notice to the patient of the healthcare provider's request. The provider system 100 permits a patient to approve, modify, or deny the healthcare provider's request to access to the patient's file. Modification may include changing one or more request parameters (e.g., time frame, data type, such as, specific laboratory results and specific documentation sources, and functional permissions, such as, ordering, document access, and timeframe of requested access). The patient feedback permits the patient to participate in their individual healthcare provider management decisions.

The hospital information system 120 includes healthcare information. The health care information generally includes case management information and/or claim processing information related to a patient's healthcare. For example, the health care information may include, without limitation and either alone or in combination: a clinical data repository 151 (e.g., active and longitudinal), documents 152, orders 154, patient census information, clinical reports, images, documents and data associated with a patient record, patient record scanned documents, detailed information about a particular patient, patient medical eligibility determination related information, patient admission, discharge, and transfer related information, patient clinical information, patient care plan information, workflow information, patient bibliographic information, patient demographic information, patient vital signs, patient financial information, and patient accounting and billing information. Particular health care information includes characteristics of the person including, without limitation, the person's age, sex, and health condition.

Preferably, the healthcare information is generated, originated, or sourced by one or more various healthcare sources within the hospital information system 120. Examples of the healthcare sources include, without limitation, a hospital system, a medical system, and a physician system, a records system, a radiology system, an accounting system, a billing system, and any other system required or desired in a system 100. The hospital system further includes, without limitation, a lab system, a pharmacy system, a financial system, and a nursing system. The medical system, otherwise called an enterprise, represents a healthcare clinic or another hospital system. The physician system represents a physician's office.

The healthcare information may be represented in a variety of file formats including, without limitation and in any combination, numeric files, text files, graphic files, video files, audio files, and visual files. The graphic files include a graphical trace including, for example, an electrocardiogram (EKG) trace, an electrocardiogram (ECG) trace, and an electroencephalogram (EEG) trace. The video files include a still video image or a video image sequence. The audio files include an audio sound or an audio segment. The visual files include a diagnostic image including, for example, a magnetic resonance image (MRI), an X-ray, a positive emission tomography (PET) scan, or a sonogram.

The workflow engine 122 enables, schedules, tracks, and escalates clinical workflow functions. The workflow engine 122 combines healthcare provider information from the repository 110 with patient information from the hospital information system 102 to identify the appropriate healthcare workers to manage tasks identified within individual clinical workflow functions.

The order processor 140 in the workflow engine 122 identifies placement of an order 154 associated with providing healthcare to the particular patient using the hospital information system 120, and identifies a particular healthcare worker initiating placement of the order 154, using the information repository 110.

The authentication processor 142 in the workflow engine 122 determines whether the particular healthcare worker (identified in the repository 110), initiating placement of the order 154, has authorization (e.g., credentials, privileging) to perform a role associated with the order and the particular patient. The authentication processor 142 permits fulfillment of the order 154 by the particular healthcare worker in response to a determination that the healthcare worker, initiating placement of the order 154, is authorized to perform the role associated with the order and the particular patient. The authentication processor 142 inhibits (i.e., prevents) fulfillment of the order 154 by the particular healthcare worker in response to a determination that the healthcare worker, initiating placement of the order 154, is not authorized to perform the role associated with the order and the particular patient.

The task listing 124 notifies an appropriate healthcare worker of a new event (e.g., result, order, document, etc.), and of the action, such as a scheduled task, that the healthcare worker is expected to take to deliver a healthcare service to a patient. The workflow engine 122 may populate the task listing 124 or it may be populated directly by the entrance of a new event.

The task scheduling processor 146 in the task listing 124 schedules performance of a task by the particular healthcare worker, performing the healthcare role for the particular patient, identified using the information repository 110. According to one aspect of the present invention, the task scheduling processor 146 schedules performance of a task by the same particular healthcare worker automatically identified using the information repository 110. Preferably, the task scheduling processor 146 automatically schedules performance of a particular healthcare associated service for a particular patient by a particular healthcare worker identified as having previously provided a similar service to the particular patient to maintain continuity of personnel relationships.

According to another aspect of the present invention, the task scheduling processor 146 uses the information repository 110 to schedule performance of a particular task by the first healthcare worker, and to initiate generation of an alert message to a second individual healthcare worker in response to a failure by the first healthcare worker to: (a) acknowledge scheduling of performance of the particular task, and/or (b) perform the task. Hence, the task scheduling processor 146 advantageously provides a backup notification system to ensure that the patient receives the healthcare service.

According to yet another aspect of the present invention, the task scheduling processor 146 enables the particular patient to: (a) schedule an appointment to receive a service performed by the particular healthcare worker in the healthcare role, and/or (b) select a healthcare worker to perform a healthcare role for the particular patient. Hence, the task scheduling processor 146 advantageously permits the patient to determine when a healthcare provider provides healthcare service and which healthcare provider provides the healthcare service.

The authentication processor 146 in the task listing 124 determines whether the particular healthcare worker has: (a) authorization, and/or (b) necessary credentials to perform the task. The authentication processor 146 permits scheduling of the task by the particular healthcare worker in response to a determination that the healthcare worker is authorized and/or has the credentials to perform the task associated with the event and the particular patient. The authentication processor 146 inhibits (i.e., prevents) scheduling of the task by the particular healthcare worker in response to a determination that the healthcare worker is not authorized and/or does not have the credentials to perform the task associated with the event and the particular patient.

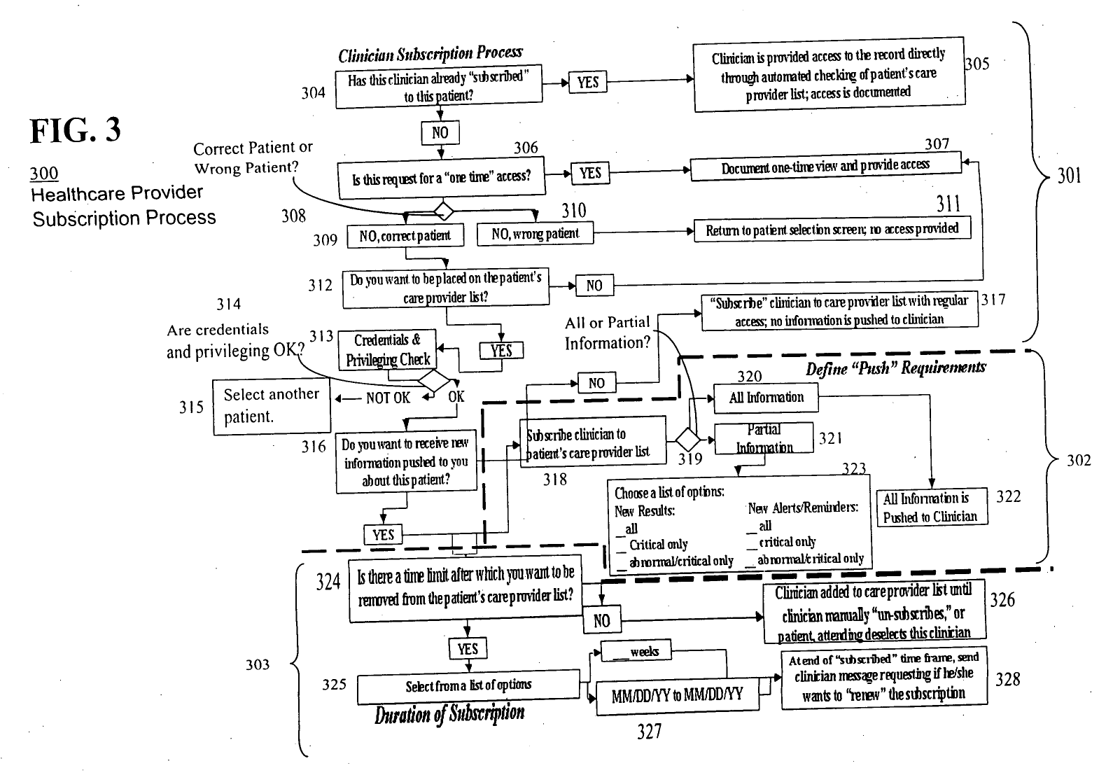

The subscription processor 126 provides a mechanism for healthcare providers to subscribe to the provider system 100 by registering their name, role, and subscription timeframe information in the repository 110. The healthcare providers may register for a particular patient or for multiple patients, whether known or unknown to the healthcare provider. FIG. 3 provides a detailed description of the subscription process 300.

In one embodiment, the provider system 100 includes the interface processor 104 and the management processor 108. The interface processor 104 receives information in one or more messages initiated by a particular healthcare worker. The received information identifies the particular healthcare worker, a particular patient, and a healthcare role identifying a work function to be performed by the particular healthcare worker for the particular patient. The management processor 108 updates an information repository 10 to include the received information.

In another embodiment, the provider system 100 supports managing personnel responsible for health care of individual patients. The provider system 100 includes the repository of information 110 and the management processor 108. The repository of information identifies, for an individual patient, multiple different healthcare roles and multiple individual healthcare workers assigned to perform the roles. The healthcare roles include roles being performed at different locations. A healthcare role identifies a work function to be performed by a healthcare worker. The management processor 108 updates the information repository 110 to include information identifying a particular individual healthcare worker assigned to perform a particular healthcare role for a particular patient in response to a received message initiated by the particular individual healthcare worker.

In a further embodiment, the provider system 100 supports ordering of healthcare related goods or services for use in providing healthcare to a patient. The provider system 100 includes the repository of information 110, the order processor 140, and the authentication processor 142. The repository of information identifies, for an individual patient, multiple different healthcare roles indicating work functions to be performed by healthcare workers, multiple individual healthcare workers assigned to perform the roles, and individual healthcare worker authorization to perform a particular role. The order processor identifies placement of an order associated with providing healthcare to a particular patient and identifies a healthcare worker, initiating placement of the order. The authentication processor 142 uses the information repository 110, in response to an identified order placement, to determine whether the healthcare worker, initiating placement of the order, has authorization to perform a role associated with the order and the particular patient.

In yet a further embodiment, the provider system 100 supports managing personnel responsible for health care of individual patients. The provider system 100 includes the repository 110 of information and the interface processor 104. The repository 110 of information identifies a particular healthcare worker, a particular patient, and a healthcare role identifying a work function to be performed by the particular healthcare worker for the particular patient. The interface processor 104 supports communication with a particular patient, and enables access of the particular patient to the repository 110 of information to identify a healthcare worker assigned to perform a healthcare role for the particular patient.

In an additional embodiment, the provider system 100 provides health care to individual patients. The provider system 100 includes the repository 110 of information and task scheduling processor 146. The repository 110 of information identifies a particular healthcare worker, a particular patient, and a healthcare role identifying a work function to be performed by the particular healthcare worker for the particular patient. The task scheduling processor 146 schedules performance of a task by the particular healthcare worker, performing the healthcare role for the particular patient, using the information repository 110, and initiates generation of a message to the particular healthcare worker notifying the particular healthcare worker of a scheduled task.

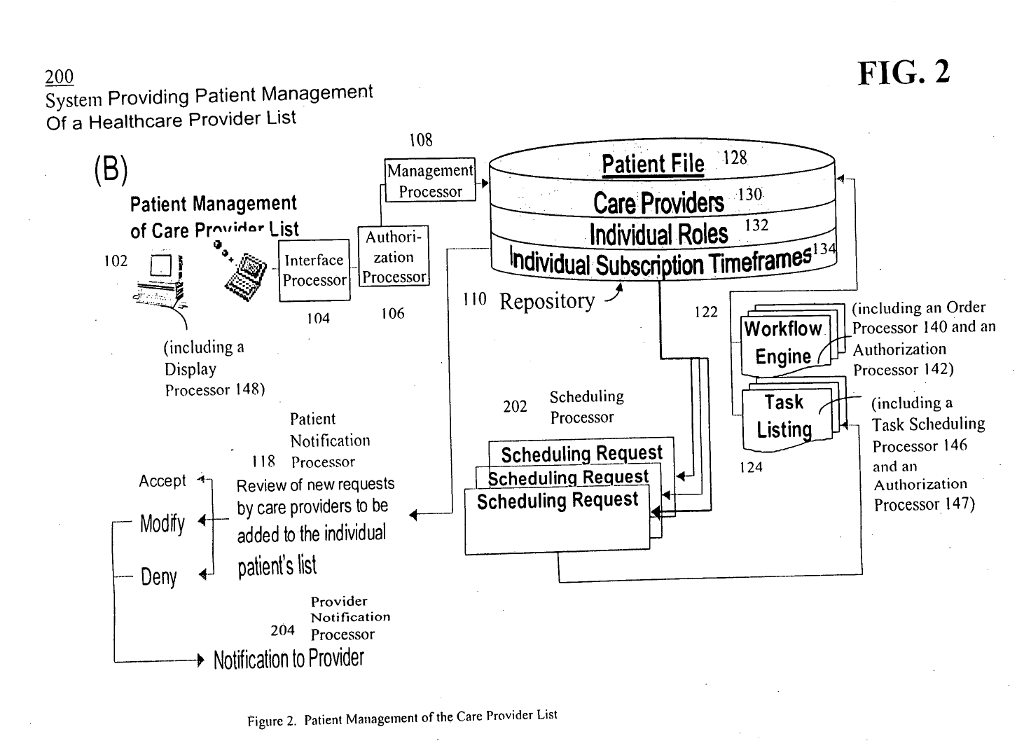

FIG. 2 shows a patient system 200 providing patient management of a healthcare provider list. The patient system 200 generally includes the electronic device 102, the interface processor 104, the authorization processor 106, the management processor 108, the repository 110, the patient notification processor 118, the workflow engine 122, the task listing 124, as shown in FIG. 1, as well as a scheduling processor 202, and a provider notification processor 204. Hence, the patient system 200 uses many similar components to those for the healthcare provider access described with reference to FIG. 1.

In the patient system 200, the electronic device 102 permits the patient to access and manage the healthcare provider information stored in the repository 110. Preferably, the electronic device 102 is a different device located in a different location than the electronic device 102 used by the healthcare provider.

The scheduling processor 202 enables a patient to access the hospital or individual departmental scheduling systems to schedule activities including but not limited to procedures or visits with healthcare providers. The patient system 200 permits healthcare organizations to enable patients to select from active healthcare providers and to select healthcare providers privileged to provide the expected services.

The provider notification processor 204 notifies the healthcare provider of the patient's response including acceptance, modification, or denial, for example, of a proposed scheduled visit (or procedure of other treatment related activity) received by the patient notification processor 118.

In the system 100 of FIG. 1 and/or the system 200 of FIG. 2, one or more elements, as shown and described herein, include one or more processors. As used herein, a processor comprises any one or combination of, hardware, firmware, and/or software. A processor acts upon stored and/or received information by manipulating, analyzing, modifying, converting, or transmitting information for use by an executable procedure or an information device, and/or by routing the information to an output device. A processor may use or comprise the capabilities of a controller or microprocessor, for example.

A processor performs tasks in response to processing an object. An object, as used herein, comprises a grouping of data and/or executable instructions, an executable procedure, or an executable application. An executable application, as used herein, comprises code or machine readable instruction for implementing predetermined functions including those of an operating system, healthcare information system or other information processing system, for example, in response user command or input. An executable procedure as used herein is a segment of code (machine readable instruction), sub-routine, or other distinct section of code or portion of an executable application for performing one or more particular processes and may include performing operations on received input parameters (or in response to received input parameters) and provide resulting output parameters. A calling procedure is a procedure for enabling execution of another procedure in response to a received command or instruction.

FIG. 3 illustrates a flowchart describing a healthcare provider subscription process 300 (herein called the “provider process”) for the subscription processor 126, as shown in FIG. 1, in accordance with a preferred embodiment of the present invention. The provider process 300 generally includes three sub-processes including a clinician subscription process 301 (including steps 304-317), a define “push” requirements process 302 (including steps 318-323), and a duration of subscription process 303 (including steps 324-328).

Clinician Subscription Process:

The clinician subscription process 301 generally describes a process by which the clinician requests and is granted access to clinical information regarding individuals (or groups of individuals). Embedded within the process is a credentials and privileging check to determine if the clinician has appropriate authority to (a) access the records and perform services of the patient or group of patients, and (b) to access any or all data elements and to perform any specified service with respect to individual patients. In particular, the clinician subscription process 301 performs the steps 304-317, described as follows.

At step 304, the system 100 determines whether the clinician has already subscribed to a particular patient. If the determination at step 304 is positive, then the process continues to step 305; otherwise, the process continues to step 306.

At step 305, the system 100 provides the clinician access to the patient's record directly through automated checking of a patient's healthcare provider list in response to a positive determination at step 304. The system 100 also documents the clinician's access to the patient's record.

At step 306, the system 100 determines whether the clinician's request is for “one time” access in response to a negative determination at step 304. If the determination at step 306 is positive, then the process continues to step 307; otherwise, the process continues to step 308.

At step 307, the system 100 provides the clinician “one time” access, preferably by viewing in response to a positive determination at step 306 or in response to a negative determination at step 312. The system 100 also documents the clinician's “one time” access to the patient's record.

At step 308, the system 100 determines whether the patient, not subscribed to by the clinician, is a correct patient or a wrong patient in response to a negative determination at step 306. If the determination at step 308 is the correct patient, then the process continues to step 309; otherwise, if the determination at step 308 is the wrong patient, then the process continues to step 310.

At step 309, the system 100 determines that the patient, not subscribed to by the clinician, is the correct patient in response to the determination at step 308.

At step 310, the system 100 determines that the patient, not subscribed to by the clinician, is the wrong patient in response to the determination at step 308.

At step 311, the system 100 returns to the patient selection screen in response to step 310. The system 100 also inhibits the clinician's access to the patient's record in response to the determination at step 310.

At step 312, the system 100 determines whether the clinician wants to be placed on the patient's care provider list in response to step 309. If the determination at step 312 is positive, then the process continues to step 313; otherwise, if the determination at step 312 is negative, then the process returns to step 307, as described above.

At step 313, the system 100 checks the credentials and the privileging for the clinician in response to a positive determination at step 312.

At step 314, the system 100 determines whether the credentials and the privileging for the clinician are appropriate for the patient in response to step 313. If the determination at step 314 is positive, then the process continues to step 316; otherwise, if the determination at step 314 is negative, then the process continues to step 315.

At step 315, the system 100 permits the clinician to select another patient and then returns to step 304, as described above, in response to a negative determination at step 314.

At step 316, the system 100 determines whether the clinician wants to receive new information pushed to the clinician about the patient in response to a positive determination at step 314. If the determination at step 316 is positive, then the process continues to step 318; otherwise, if the determination at step 316 is negative, then the process continues to step 317.

At step 317, the system 100 subscribes the clinician to a healthcare provider list with regular access in response to a negative determination at step 316. The system 100 does not push information to the clinician.

Define “Push” Requirements Process:

The define “push” requirements process 302 generally describes a process by which clinicians define preferences for receipt of information that can be sent to them directly. This capability allows clinicians to define parameters for notification regarding data types. Notification parameters are configurable to allow for changes in communication technology. Definitions of preferences within available parameters are the purview of the individual care provider; healthcare organizations are able to limit an individual's ability to configure notification parameters. Parameters are also provided based on data element specifications (e.g., status update, critical, significantly changed, etc.). In particular, the define “push” requirements process 302 performs the steps 318-323, described as follows.

At step 318, the system 100 subscribes the clinician to the patient's care provider list in response to a positive determination at step 316.

At step 319, the system 100 determines whether the clinician wants all or some (i.e., a portion) of the information about the patient pushed to the clinician in response to step 318. If the determination at step 319 is all information, then the process continues to step 320; otherwise, if the determination at step 319 is some information, then the process continues to step 321.

At step 320, the system 100 determines that the clinician wants all of the information about the patient pushed to the clinician in response to an “all information” determination at step 319.

At step 321, the system 100 determines that the clinician wants some of the information about the patient pushed to the clinician in response to a “some information” determination step 319.

At step 322, the system 100 pushes all of the information to the clinician in response to step 320.

At step 323, the system 100 pushes some of the information to the clinician in response to step 321. The clinician may select from a list of options including, for example, new results and new alerts/reminders. The new results option includes, for example, all new results, only critical new results, and only abnormal/critical new results. The new alerts/reminders option includes, for example, all new alerts/reminders, only critical new alerts/reminders, and only abnormal/critical new alerts/reminders.

Duration of Subscription Process:

The duration of subscription process 303 generally describes a process, which clinicians define a period during which the individual care provider wishes to access information and provide care as the duration of the subscription. Default values are automated such that providers associated with the patient's care during a hospitalization receive automatic notification to determine if they plan to continue with the patient's management after discharge (default value is “no” except for role of primary care physician). Duration granularity may be defaulted to time-based care assignments (e.g., nursing care by shift) and may include a range from one-time-only to the duration of the care episode, to continuous care regardless of care delivery site. In particular, the duration of subscription process 303 performs the steps 324-328, described as follows.

At step 324, the system 100 determines whether there is a time limit after the clinician wants to be removed from the patient's healthcare provider list. If the determination at step 324 is positive, then the process continues to step 325; otherwise, if the determination at step 324 is negative, then the process continues to step 326.

At step 325, the system 100 provides the clinician a list of options for the duration of the subscription in response to step 324.

At step 326, the system 100 adds the clinician to the patient's healthcare provider list

At step 327, the system 100 receives the clinician's selection from the list of options in response to step 325. The selection includes, for example, a number of weeks (weeks), or a number of days (i.e., MM/DD/YY to MM/DD)/YY).

At step 328, the system 100 sends the clinician a message asking the clinician if the clinician wants to renew the subscription at the end of the time for the subscription in response to step 324.

According to one combination of features of the present invention, the method 100 provides health care to individual patients by performing the steps of receiving and updating. The provider system 100 performs the step of receiving, in one or more messages initiated by a particular healthcare worker, information identifying, the particular healthcare worker, a particular patient, and a healthcare role identifying a work function to be performed by the particular healthcare worker for the particular patient. The provider system 100 also performs the step of updating an information repository 110 to include the received information.

According to another combination of features of the present invention, the method 100 supports providing health care to individual patients by performing the steps of identifying and updating. The provider system 100 performs the step of identifying, for an individual patient, multiple different healthcare roles and multiple individual healthcare workers assigned to perform the roles. The healthcare roles include roles being performed at different locations. A healthcare role identifies a work function to be performed by a healthcare worker. The provider system 100 performs the step of updating an information repository 110 to include information identifying a particular individual healthcare worker assigned to perform a particular healthcare role for a particular patient in response to a received message initiated by the particular individual healthcare worker.

According to yet another combination of features of the present invention, the method 100 supports ordering of healthcare related goods or services for use in providing healthcare to a patient by performing the following steps. The provider system 100 performs the step of identifying, for an individual patient, multiple different healthcare roles indicating work functions to be performed by healthcare workers, multiple individual healthcare workers assigned to perform the roles, and individual healthcare worker authorization to perform a particular role. The provider system 100 also performs the step of identifying placement of an order associated with providing healthcare to a particular patient, and performs the step of identifying a healthcare worker, initiating placement of the order. The provider system 100 further performs the step of determining whether the healthcare worker, initiating placement of the order, has authorization to perform a role associated with the order and the particular patient, in response to an identified order placement.

According to still yet another combination of features of the present invention, the method 100 supports patient access to health care information by performing the following steps. The patient system 200 performs the step of maintaining a repository 110 of information identifying: a particular healthcare worker, a particular patient, and a healthcare role identifying a work function to be performed by the particular healthcare worker for the particular patient. The patient system 200 also performs the step of supporting communication with a particular patient, and enabling access of the particular patient to the repository 110 of information to identify a healthcare worker assigned to perform a healthcare role for the particular patient.

FIG. 4 illustrates a presentation 400 displayed to a healthcare provider for the process 300, as shown in FIG. 3, in accordance with a preferred embodiment of the present invention. The presentation 400 generally includes a subscription process presentation 401, a duration of subscription process presentation 402, and a define “push” requirements process presentation 403.

The subscription process presentation 401 further includes a notice section 404 and six options 405-410. The notice section 404 states, for example, “You have requested access to the clinical record for Ed Voxx. Access to clinical records is a privilege provided only to those individuals with the need to know to provide appropriate clinical care. Your activities will be audited from this point forward. Please select one option:”

The six options 405-410 further include: “Cancel Request—Sorry, wrong patient.” 405 “One time view request for clinical management.” 406 “One time view request for clinical research.” 407 “Please add me to the patients care provider list for continued access, but do not send me any results or alerts about this patient.” 408 “Please add me to the patient's care provider list for continued access and send to my inbox all new results, alerts, and reminders.” 409 “Please add me to the patient's care provider list for continued access but I want to select which information I want to receive in my inbox.” 410

The duration of subscription process presentation 402 further includes two options including, for example, “I want to continue to access this patient's clinical record for an indefinite time period.” 411, and “I want to continue to access this patient's clinical record from MM/DD/YY to MM/DD/YY.” 412.

The define “push” requirements process presentation 403 further includes a list of options described as: “Choose a list of options: 413 New Results: all, critical only, abnormal/critical only, New Alerts/Reminders: all, critical only, abnormal/critical only.”

Individual care providers are presented with individualized subscription possibilities for use with patients by category (e.g., admitting, consulting, ambulatory) or which can be used individually when requesting access to each patient record. FIG. 4 provides an example of the options that can be provided to each care provider with respect to patient access subscriptions. FIG. 4 is presented as an example; the actual content within each area of definition is customizable based on usage of the system.

The systems 100, 200 advantageously permit patients to assist in care management. The systems 100, 200 provide a role-based notification methodology to manage a list of collaborative care providers and the authorities and responsibilities of each provider. Automated systems 100, 200 provide a logical flow of the functions authenticating the safe delivery of patient care.

The systems 100, 200 provide tools that are incorporated into any user interface that permits an individual healthcare provider to subscribe to individual patients based on the healthcare provider's preference. A healthcare provider can select one or more of the following:

The healthcare provider's role is selected from a default listing. A healthcare system and an individual department may modify the default listing.

The time frame during which the healthcare provider wants to be associated with the patient, and if the healthcare provider wants the option of renewing at the end of the time frame and/or of being notified when the time frame has ended.

A safeguard prevents primary caregivers (e.g., attending physicians, primary nurses) from disassociating with individual patients, unless there is a transfer of primary responsibilities. A transfer is managed systematically for pre-scheduled changes in service. If transfers are performed manually, the receiving healthcare provider is required to accept the transfer before the first healthcare provider is removed from the primary assignment;

The type of information the healthcare provider prefers to be notified about.

Default settings that assign certain types of information to specified roles (defaults are health system and individual department modifiable).

The level of responsibility the healthcare provider wishes to have for the type of information selected. The primary caregivers have authority to override individual healthcare provider selections of responsibility, or to allow co-management by having multiple individuals accept responsibility. In the absence of a selection, the primary caregivers (role-based) have system generated responsibility assignments by data type.

The system 100, 200 gives patients the authority to override individual healthcare provider selections of responsibility. The systems 100, 200 gives patient assignment of responsibility for data types to individual care providers, but requires acceptance of such responsibility (including a time frame) by each individual care provider.

The system 100 provides the ability to manage clinical caregiver authority for selections of patients and data types based on individual clinical privileges and credentials. Credentialing and privileging are primarily administrative processes that allow verification of the credentials (education, certification and licenses) of individual healthcare providers. Part of the credentialing process in healthcare organizations is to create a set of privileges (i.e., procedures and treatments the caregiver is allowed to provide within the setting). Privileges may allow full access to providing certain services, limited access (e.g., with supervision) for other services, restricted access (e.g., only in specified situations) for other services, and blocked access for still other services. Privileges are assigned based on education, training and experience and, increasingly, based on performance measurement (i.e., achievement of specified threshold levels of positive outcomes). The systems 100, 200 advantageously link credentialing and privileging levels with clinical care coordination within clinical information systems.

The systems 100, 200 advantageously support coordination of authority for patient care subscription based on established credentials and privileges in the healthcare organization.

The systems 100, 200 advantageously provide coordination of authority for individual orders and patient-data level access based on established credentials and privileges in the healthcare organization.

The systems 100, 200 are incorporated into patient management, clinical results, documentation and order management aspects of a health care information system. The systems 100, 200 provide a detailed workflow architecture supporting management of localized and cross-organization health care among the multiple care providers involved in each patient's care process. The systems 100, 200 provide one or more of following advantages:

1. Significantly reduced maintenance requirements for information system resources to manage individual clinician roles and relationships with individual patients.

2. Individual clinicians have the ability to manage multiple patients with different roles and responsibilities, enabling a true collaborative model of care delivery.

3. A health system having the capacity to allow patients to manage their relationships with individual clinical caregivers.

4. The individual caregiver has the ability to personalize notification preferences by data type, within limits set by the individual healthcare institution or clinical department. The underlying infrastructure and toolset manages the process within multiple user interface design configurations.

5. Providing a safety check that the caregiver asking for authority to access a specific patient or data type, or to perform a specific procedure has the appropriate credentials and privileges in the respective care setting.

6. Significantly reduced maintenance requirements for care provider lists since each provider manages the care provider lists on subscription basis.

7. Automated management of individual clinician roles and relationships with individual patients.

8. Permitting individual care providers to establish individualized roles based on individual patient needs and care provider capabilities.

9. Permitting individual caregivers to personalize notification preferences by data type, within limits set by an individual healthcare institution or clinical department.

10. Ensuring comprehensive patient care coverage and eliminate service gaps.

11. Collaborative care management enabled by the creation of an active, up-to-date list of caregivers for any individual patient, including responsibilities of each.

12. Individual caregivers are identified by role and validated that credentials and privileges are sufficient to allow for that role.

13. List maintenance issues to not encumber information system human resources by allowing caregivers to subscribe on their own to individual patients and data elements.

In summary of a preferred embodiment of the present invention, the systems 100, 200 address problematic issues in healthcare delivery worldwide (e.g., which care provider is managing each specific clinical issue related to individual patients for a specified time frame). The systems 100, 200 provide management of individual provider preferences regarding patient lists, or census, as well as role-based collaborative care. “Patient-Centered Care Provider Census” system 100 permits provider's security-enabled access to subscribe to patients based on the provider's specific role and established clinical privileges for provider-specified data types and periods. The ability for individual clinical care providers to manage these relationships frees the clinical care entity (e.g., hospital, ambulatory care group, managed care organization, etc.) from the cumbersome administrative task of managing patient care relationships and permits organizations to provide patients access to manage their own care provider relationships. The systems 100, 200 also enable notification engines to effectively identify the provider most appropriate to manage specific data types (e.g., new, changed or delayed parameters such as clinical results, orders, scheduling actions, etc.) and incorporate a collaborative care approach.

The various features of the present invention may be combined in different ways to provide advantageous aspects of the provider system 100, the patient system 200, the process 300, and/or the presentation 400. The combinations disclosed herein reflect various ways the systems, method, and presentation may be used or implemented by various persons or organizations. The combinations disclosed herein are provided only as examples and should not be construed as being the only combinations or limited in any way.

Preferably, the various functions are shown as separate functional blocks only for purposes of illustration and description, and are not intended to be limiting. For example, the authorization processors 106, 142, 147, and 150 may be implemented as the same or different processors, as required or desired. The various functions of the provider system 100 and/or the patient system 200 may be implemented in any combination of software and/or hardware, and may be combined in any manner. The systems 100, 200 may be structured in different layers of granularity. For example, traditionally, credentialing and privileging systems are isolated and are used for maintenance of accreditation and performance management activities. Hence, the credentialing and privileging systems may be incorporated by communication links or integrated into the systems 100, 200. The systems 100, 200 also support authority and role-based access to privileging files.

The systems 100, 200 are also applicable to non-healthcare related fields, wherein individuals maintain their own access profiles and customers of those individuals can be enabled to manage those acting on their behalf. Examples of other non-healthcare related fields include, without limitation, financial asset maintenance, on-call responsibilities for health care and other industries, and customer service in any industry where individuals maintain their own profiles.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A system for supporting providing health care to individual patients, comprising:
an interface processor for receiving information in at least one message initiated by a particular healthcare worker, said received information identifying,
said particular healthcare worker,
a particular patient, and
a healthcare role identifying a work function to be performed by said particular healthcare worker for said particular patient; and
a management processor for updating an information repository to include said received information.

2. A system according to claim 1, wherein
said received information identifies at least one of, (a) a start date of said particular healthcare worker being assigned to perform said particular healthcare role, (b) an end date of said particular healthcare worker being assigned to perform said particular healthcare role, (c) a type of data said particular healthcare worker is authorized to access, (d) authorization of said particular healthcare worker to perform said particular healthcare role, and (e) credentials of said particular healthcare worker.

3. A system according to claim 1, including
a task scheduling processor for scheduling performance of a task by said particular healthcare worker performing said healthcare role for said particular patient, said particular healthcare worker being identified using said information repository.

4. A system according to claim 3, including
an authentication processor for determining whether said particular healthcare worker has at least one of, (a) authorization, and (b) necessary credentials to perform said task.

5. A system according to claim 1, including
a display processor for initiating generation of at least one display image supporting user entry of said received information.

6. A system according to claim 1, wherein
said interface processor receives information identifying, a type of data said particular healthcare worker is authorized to access and a notification communication method said particular healthcare worker desires to be used in communicating said type of data to said particular healthcare worker.

7. A system according to claim 1, wherein
an order processor for identifying placement of an order associated with providing healthcare to said particular patient and for identifying a particular healthcare worker initiating placement of said order, using said information repository.

8. A system according to claim 7, including
an authentication processor for determining whether said particular healthcare worker initiating placement of said order has authorization to perform a role associated with said order and said particular patient.

9. A system supporting managing personnel responsible for health care of individual patients, comprising:
a repository of information identifying, for an individual patient, a plurality of different healthcare roles and a plurality of individual healthcare workers assigned to perform said roles, said healthcare roles including roles being performed at different locations and a healthcare role identifying a work function to be performed by a healthcare worker; and
a management processor for updating said information repository to include information identifying a particular individual healthcare worker assigned to perform a particular healthcare role for a particular patient in response to a received message initiated by said particular individual healthcare worker.

10. A system according to claim 9, wherein
said information repository identifies for an individual patient, a plurality of different healthcare roles associated with a plurality of different organizations and performed at different locations associated with said different organizations.

11. A system according to claim 9, wherein
said roles include healthcare work functions associated with different parts of a treatment regimen including work functions associated with two or more of, (a), examination, (b) laboratory testing, (c) diagnosis, (d) treatment, (e) post-treatment, (f) therapy, and (g) physiotherapy.

12. A system according to claim 9, wherein
said role includes at least one of, (a) a nurse work function, (b) a physician work function, (c) an administrative work function, (d) a therapist work function, (d) a case manager work function, (e) a home aid work function, (f) a laboratory test support work function, (g) a technician work function, (h) a care unit support work function, (i) a nurse practitioner work function, (j) a physician assistant work function, and (k) a cleaning and resource supply work function.

13. A system according to claim 9, wherein
said roles include a role performed by a healthcare worker during an inpatient stay in a hospital and performed by a healthcare worker outside of said hospital, and
said roles include clinical and administrative healthcare worker roles.

14. A system according to claim 9, including
a task scheduling processor for scheduling performance of a task by a particular healthcare worker automatically identified using said information repository, said scheduled task being involved in delivering healthcare to a patient.

15. A system according to claim 14, wherein
said task scheduling processor automatically schedules performance of a particular healthcare associated service for a particular patient by a particular healthcare worker identified as having previously provided a similar service to said particular patient to maintain continuity of personnel relationships.

16. A system according to claim 9, wherein
said repository includes information identifying, for an individual patient, a healthcare role and a first individual healthcare worker assigned to perform said role, and a second individual healthcare worker to be informed in response to failure to acknowledge a task scheduled to be performed by said first individual healthcare worker.

17. A system according to claim 9, including
a task scheduling processor for using said information repository for scheduling performance of a particular task by said first healthcare worker and for initiating generation of an alert message to a second individual healthcare worker in response to a failure by said first healthcare worker to at least one of, (a) acknowledge scheduling of performance of said particular task, and (b) perform said task.

18. A system according to claim 9, wherein
said repository of information identifies a plurality of prioritized individual healthcare workers for assignment to perform a particular healthcare role for a particular patient in a predetermined order based on worker availability.

19. A system according to claim 9, including
an authentication processor for determining whether an individual healthcare worker has at least one of, (a) authorization, and (b) necessary credentials to perform a particular role.

20. A system according to claim 19, wherein
said necessary credentials comprise at least one of, (i) educational qualifications, (ii) regulatory licenses, (iii) healthcare provider organization determined privileges, (iv) certifications, and (v) medical specialty qualifications.

21. A system according to claim 19, wherein
said authentication processor determines whether said individual healthcare worker has authorization to access patient medical data of a particular type.

22. A system according to claim 19, wherein
in response to a determination said individual healthcare worker is unauthorized to perform said particular role, said authentication processor at least one of, (a) inhibits update of said information repository to include information identifying said individual healthcare worker as being assigned to perform a particular healthcare role for a particular patient, (b) inhibits scheduling of a particular task for performance by said individual healthcare worker for a particular patient, and (c) initiates generation of an alert message to a predetermined user warning of said non-authorization determination.

23. A system according to claim 9, including
said repository of information identifies an individual healthcare worker assigned to perform a particular healthcare role for a particular patient and also identifies at least one of, (a) a start date of said individual healthcare worker being assigned to perform said particular healthcare role, (b) an end date of said individual healthcare worker being assigned to perform said particular healthcare role, (c) a type of data said individual healthcare worker is authorized to access, (d) authorization of said individual healthcare worker to perform said particular healthcare role, and (e) credentials of said individual healthcare worker.

24. A system according to claim 9, including
an interface processor supporting communication with a particular patient and enabling access of said particular patient to said repository of information to at least one of, (a) identify a healthcare worker assigned to perform a healthcare role for said particular patient, and (b) select a healthcare worker to perform a healthcare role for said particular patient.

25. A system supporting ordering of healthcare related goods or services for use in providing healthcare to a patient, comprising:
a repository of information identifying, for an individual patient,
a plurality of different healthcare roles indicating work functions to be performed by healthcare workers,
a plurality of individual healthcare workers assigned to perform said roles, and
individual healthcare worker authorization to perform a particular role,
an order processor for identifying placement of an order associated with providing healthcare to a particular patient and for identifying a healthcare worker initiating placement of said order;
an authentication processor for using said information repository, in response to an identified order placement, to determine whether said healthcare worker initiating placement of said order has authorization to perform a role associated with said order and said particular patient.

26. A system according to claim 25, wherein
said repository of information identifies, for said individual patient, whether an individual healthcare worker has necessary credentials to perform a particular role, and
said authentication processor determines whether said healthcare worker initiating placement of said order has necessary credentials to perform said role associated with said order and said particular patient.

27. A system according to claim 25, wherein
in response to a determination said healthcare worker initiating placement of said order is unauthorized to perform said role associated with said order and said particular patient, said authentication processor inhibits fulfillment of said order.

28. A system for supporting managing personnel responsible for health care of individual patients, comprising:
a repository of information identifying,
a particular healthcare worker,
a particular patient, and
a healthcare role identifying a work function to be performed by said particular healthcare worker for said particular patient; and
an interface processor supporting communication with a particular patient, and enabling access of said particular patient to said repository of information to identify a healthcare worker assigned to perform a healthcare role for said particular patient.

29. A system according to claim 28, including
a scheduling processor enabling said particular patient to at least one of, (a) schedule an appointment to receive a service performed by said particular healthcare worker in said healthcare role, and (b) select a healthcare worker to perform a healthcare role for said particular patient.

30. A method supporting providing health care to individual patients, comprising the activities of:
receiving, in at least one message initiated by a particular healthcare worker, information identifying,
said particular healthcare worker,
a particular patient, and
a healthcare role identifying a work function to be performed by said particular healthcare worker for said particular patient; and
updating an information repository to include said received information.

31. A system supporting providing health care to individual patients, comprising:
a repository of information identifying,
a particular healthcare worker,
a particular patient, and
a healthcare role identifying a work function to be performed by said particular healthcare worker for said particular patient; and
a task scheduling processor for,
scheduling performance of a task by said particular healthcare worker performing said healthcare role for said particular patient, said particular healthcare worker being identified using said information repository and
initiating generation of a message to said particular healthcare worker notifying said particular healthcare worker of a scheduled task.

32. A method supporting providing health care to individual patients, comprising the activities of:
identifying, for an individual patient, a plurality of different healthcare roles and a plurality of individual healthcare workers assigned to perform said roles, said healthcare roles including roles being performed at different locations and a healthcare role identifying a work function to be performed by a healthcare worker; and
updating an information repository to include information identifying a particular individual healthcare worker assigned to perform a particular healthcare role for a particular patient in response to a received message initiated by said particular individual healthcare worker.

33. A method supporting ordering of healthcare related goods or services for use in providing healthcare to a patient, comprising the activities of:
identifying, for an individual patient,
a plurality of different healthcare roles indicating work functions to be performed by healthcare workers,
a plurality of individual healthcare workers assigned to perform said roles, and
individual healthcare worker authorization to perform a particular role,
identifying placement of an order associated with providing healthcare to a particular patient and for identifying a healthcare worker initiating placement of said order;
determining whether said healthcare worker initiating placement of said order has authorization to perform a role associated with said order and said particular patient, in response to an identified order placement.

34. A method for supporting patient access to health care information, comprising the activities of:
maintaining a repository of information identifying,
a particular healthcare worker,
a particular patient, and
a healthcare role identifying a work function to be performed by said particular healthcare worker for said particular patient; and
supporting communication with a particular patient and enabling access of said particular patient to said repository of information to identify a healthcare worker assigned to perform a healthcare role for said particular patient.
